(19) United States
(12) Patent Application Publication
(10) Pub. No.: US 2014/0041185 A1
(43) Pub. Date: Feb. 13, 2014

(54) ELASTIC TUBE ALIGNMENT AND ATTACHMENT SYSTEM AND METHOD FOR PRECISELY LOCATING AND ATTACHING COMPONENTS

(71) Applicant: GM GLOBAL TECHNOLOGY OPERATIONS LLC, Detroit, MI (US)

(72) Inventors: Steven E. Morris, Fair Haven, MI (US); Edward D. Groninger, Macomb, MI (US); Raymond J. Chess, Oxford, MI (US)

(73) Assignee: GM GLOBAL TECHNOLOGY OPERATIONS LLC, Detroit, MI (US)

(21) Appl. No.: 13/956,813

(22) Filed: Aug. 1, 2013

Related U.S. Application Data
(60) Provisional application No. 61/682,728, filed on Aug. 13, 2012.

(51) Int. Cl. F16B 17/00

(52) U.S. Cl. CPC F16B 17/00
USPC 29/407.09; 403/13

(57) ABSTRACT

An elastic tube alignment system for the mating of components utilizing the principle of elastic averaging. A plurality of geometrically separated elastic tube (male) alignment and attachment features are disposed on a first component, while a plurality of one-to-one corresponding aperture (female) alignment and attachment features are provided on a second component. During the mating of the components, each elastic tube and its respective aperture provide elastic deformation, which, on average, precisely aligns and attaches the components.

### CROSS REFERENCE TO RELATED APPLICATIONS

This application claims the benefit of U.S. Provisional Application Ser. No. 61/682,728, filed Aug. 13, 2012, which is incorporated herein by reference in its entirety.

### FIELD OF THE INVENTION

The subject invention relates to location and attachment features for alignment and attachment of components during a mating operation. More particularly, the subject invention relates to a plurality of mutually spaced apart elastic tube alignment and attachment features of a first component which elastically deform on average when mated to receiving aperture alignment features and attachment features of a second component to thereby precisely align and attach the first and second components during a mating operation.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

To align and secure components, the aforementioned male and female alignment features may be employed in combination with separate fastening elements that serve to secure the components to each other. In such an assembly, the mating components are located relative to each other by the alignment features, and are fixed relative to each other by the separate fastening elements. Use of separate alignment features and fastening elements, one for alignment and the other for securement, may limit the effectiveness of each on a given assembly, as the alignment features cannot be employed where the fastening elements are employed.

By way of example, FIGS. 1 through 3 illustrate the prior art location modality for the aligning of two components as they are being mutually mated.

A first component 10 has a plurality of male alignment features in the form of an upstanding elongated rib 12 and spaced therefrom an upstanding four-pronged stud 14. A second component 16 has a plurality of female alignment features in the form of a narrow slot 18 disposed at an end and a wide slot 20 disposed at the opposite end. The additional slots 22 of the second component 16 are intended to provide clearance for threaded fasteners 24 to be screwed into screw receiving holes 26 of the first component 10.

As best shown at FIG. 2, the elongated rib 12 is loosely received into the narrow slot 18, wherein the spacing 30 between the sides 18a of the narrow slot and the sides 12a of the elongated rib allow spacing therebetween for accommodating manufacturing variances. Similarly, as best shown at FIG. 3, the pronged stud 14 is loosely received into the wide slot 20, wherein the spacing 30 between the sides 20a of the wide slot and the sides 14b of the prongs 14a of the pronged stud allow spacing therebetween for accommodating manufacturing variances. For example, the spacing (or gap, or clearance) 30 between the male and female alignment features may be 0.6 mm, whereby the error of mating of the first component to the second component may be up to about 1.2 mm as a cross-car and up-down float.

In operation, as the first and second components are mated together, the initial contact therebetween occurs when the elongated rib passes into the narrow slot and the pronged stud passes into the wide slot, whereby the first and second components are brought into a general alignment to one another. The larger size of the narrow slot in relation to the elongated rib and the larger size of the wide slot in relation to the pronged stud allow the mating to proceed smoothly and effortlessly as the first and second components mate, even if there is present manufacturing variance in terms of size and position of the alignment features. Problematically, however, there is considerable float as between the elongated rib in relation to the narrow slot and as between the pronged stud and the wide slot. This float (or play), as mentioned above, allows for the first component to be aligned relative to the second component generally, but not precisely. When the threaded fasteners are screwed in to attach the components to one another, any misfit of alignment becomes manifest, and the visible joint between the two components may be irregular, have too large a gap, be unbalanced in appearance, etc., in any event the misfit of alignment rendering the fit unacceptable for a Class A finish.

Accordingly, what remains needed in the art is to somehow provide an alignment and attachment modality for the mating of components, wherein when mating is completed there is a lack of play as between the male and female alignment features so as to provide a precision alignment and a secure attachment of the components, yet the aligned mating proceeds smoothly and effortlessly each time until the components are attached to one another.

### SUMMARY OF THE INVENTION

An exemplary embodiment of the invention includes an elastic tube alignment and attachment system for aligning components to each other that includes a first component and a second component. A plurality of upstanding, axially-extending elastic tubes are connected to at least one of the first and second components, each elastic tube having a tube wall. A plurality of apertures are formed in at least one of the first and second components, each aperture having an aperture wall. A plurality of first attachment features are disposed on the plurality of upstanding elastic tubes or the plurality of apertures. A plurality of corresponding second attachment features are disposed on the other of the plurality of upstanding elastic tubes or the plurality of apertures. The plurality of apertures are geometrically distributed in coordinated relationship to a geometrical distribution of the plurality of elastic tubes such that each elastic tube is receivable into a respective aperture. When each elastic tube is received into its respective aperture an elastic deformation occurs at an interface between the tube wall and the aperture wall, wherein the elastic deformation is responsive to each tube wall having a diameter larger than a cross-section of its respective aperture. The elastic deformation is elastic averaged over the plurality of elastic tubes such that the first component is precisely located relative to the second component. The first attachment features and corresponding second attachment features are selectively engageable to attach the first component to the second component.

Another exemplary embodiment of the invention includes a method for precisely aligning and attaching components of a motor vehicle during a mating operation. In the method, a first and a second vehicle component is provided. Either of the first and second vehicle components are provided with a plurality of upstanding elastic tubes and a plurality of apertures formed therein, wherein the plurality of apertures are geometrically distributed in coordinated relationship to a geometrical distribution of the plurality of elastic tubes such that each elastic tube is matingly engageable into a respective aperture, the plurality of upstanding elastic tubes having one of a first attachment feature or a second attachment feature disposed thereon and the corresponding plurality of apertures having the other of the first attachment feature or the second attachment feature disposed thereon, the first attachment features being selectively engageable with the second attachment features. The first vehicle component is mated to the second vehicle component by pressing the components together, wherein during pressing the first vehicle component is aligned to the second vehicle component by each elastic tube being received into its respective aperture. An interface between each elastic tube and its respective aperture is elastically deformed. The elastic deformation is elastically averaged over the plurality of elastic tubes such that upon mating, a precise location of the first vehicle component to the second vehicle component transpires. The first component is attached to the second component during pressing by selectively engaging the first attachment features and their respective second attachment features.

This and additional objects, features and advantages of the invention will become clearer from the following description of an exemplary embodiment.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a first component generally aligned to a second component before final assembly by threaded fasteners, wherein a prior art alignment modality is utilized;

FIG. 2 is a detail, cut-away view, seen at demarcation 2 of FIG. 1;

FIG. 3 is a detail, cut-away view, seen at demarcation 3 of FIG. 1;

FIG. 4 is a perspective view of a first component generally aligned to a second component before final assembly by threaded fasteners, wherein the view is similar to FIG. 1 except now an elastic tube alignment system according to an embodiment of the invention is utilized;

FIG. 5 is a partly sectional view, seen along line 5-5 of FIG. 4, wherein a final stage of mating between the first and second components is shown;

FIG. 6 is a partly sectional view, similar to FIG. 5, wherein a first stage of mating between the first and second components is shown;

FIG. 7 is a partly sectional view, similar to FIG. 5, wherein an intermediate stage of mating between the first and second components is shown;

FIG. 8 is a partly sectional view similar to FIG. 5, wherein now the first and second components each have an elastic tube and aperture alignment feature according to an embodiment of the invention;

FIG. 9 is a perspective view of an exemplary embodiment of an alignment and attachment feature as disclosed herein;

FIG. 10A is a partial sectional view along cut line 10-10 of FIG. 9 in accordance with an embodiment of the invention;

FIGS. 10B-10E are partial sectional views similar to that of FIG. 10A, but of several other exemplary embodiments of alignment and attachment features as disclosed herein;

FIG. 11 is a plan view of an exemplary embodiment of a peripherally-extending protrusion as disclosed herein;

FIG. 12 is a plan view of an exemplary embodiment of a peripherally-extending protrusion comprising two peripherally-extending portions; and

FIG. 13 is a flowchart of an exemplary embodiment of a method of an elastic tube alignment and attachment system as disclosed herein.

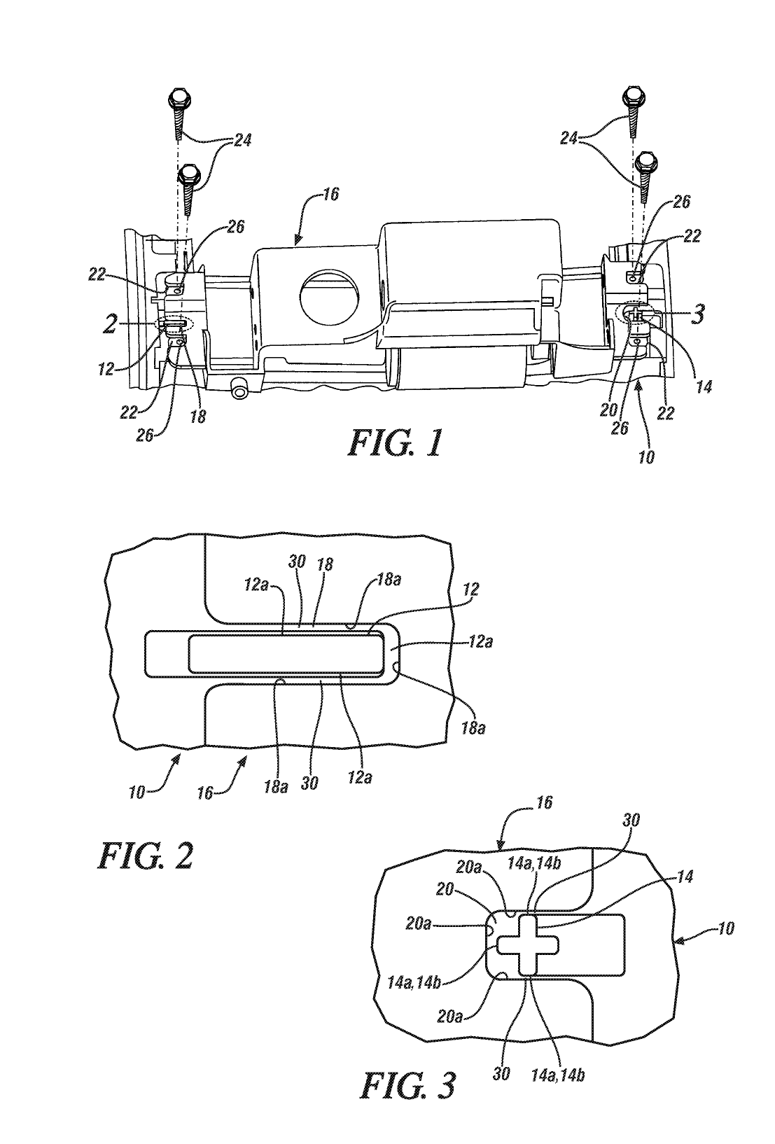

### DESCRIPTION OF THE EMBODIMENTS

The following description is merely exemplary in nature and is not intended to limit the present disclosure, its application or uses. For example, the embodiments shown comprise vehicle components but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

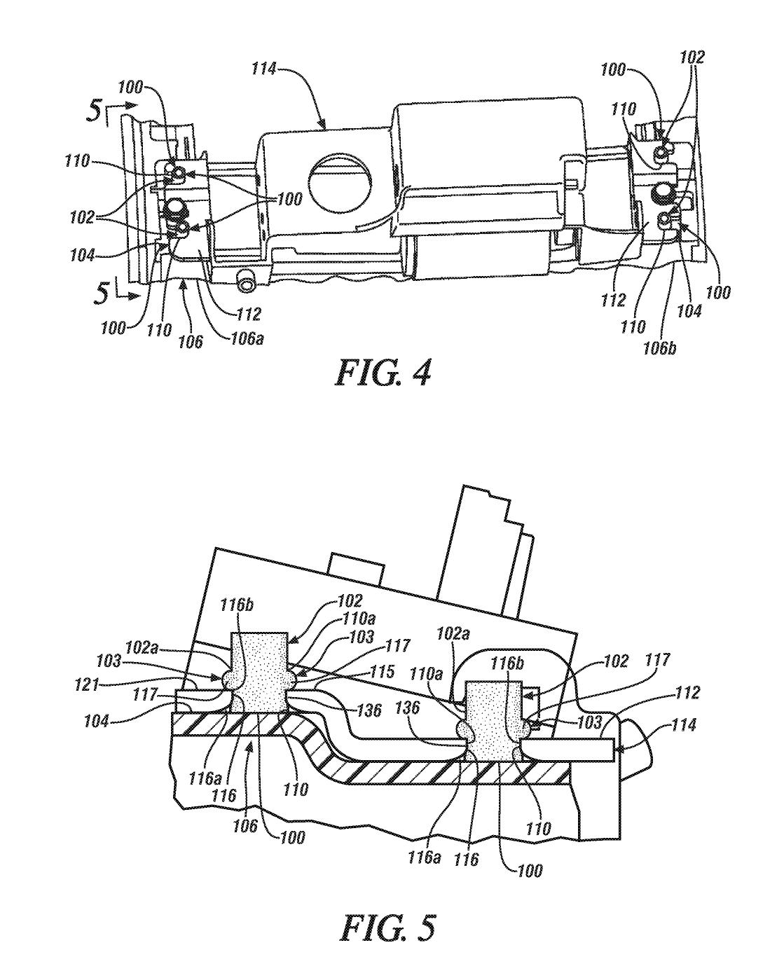

Referring now to the Drawings, FIGS. 4 through 13 depict various examples of the structure and function of the elastic tube alignment and attachment system according to the invention.

Referring firstly to FIGS. 4 through 8, the general principles of the elastic tube alignment and attachment system 100 according to the invention will be detailed.

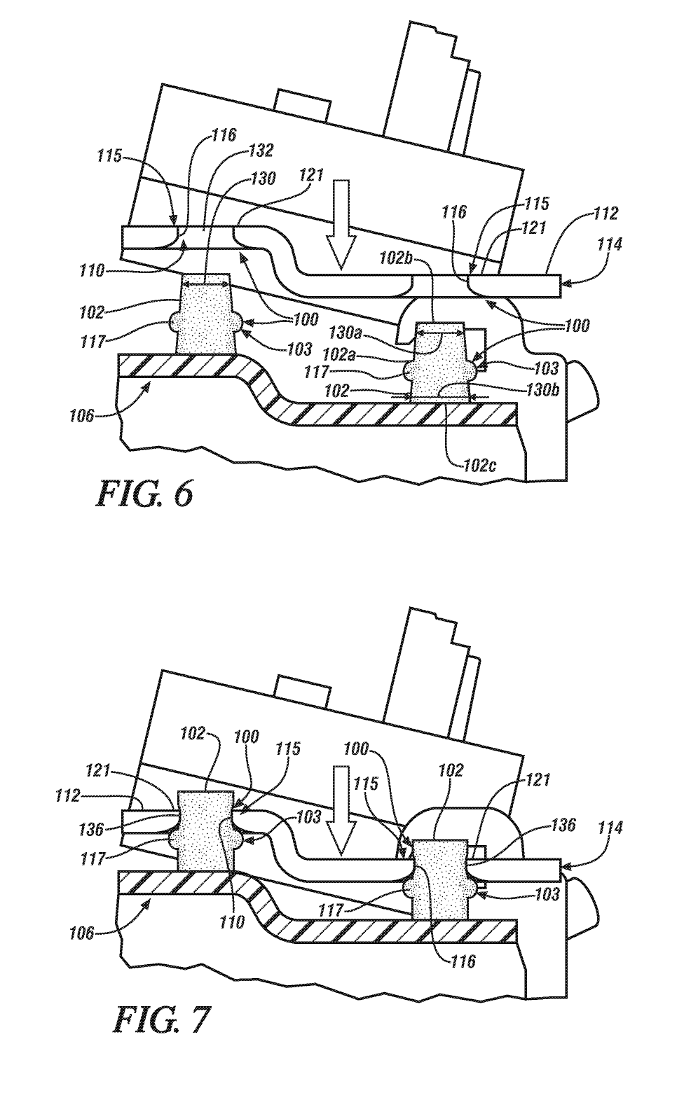

A plurality of mutually separated elastic hollow tube alignment features (serving as male alignment features) 102 (hereinafter referred to simply as “elastic tubes”) are disposed on a first surface 104 of a first component 106. As best shown at FIG. 5, the elastic tubes 102 are upstanding in normal relation to the first surface 104, wherein a mutually separated pair of elastic tubes is disposed at both a left end 106a and a right end 106b of the first component 106. Each of the elastic tubes 102 is tubular in shape, having a tube wall 102a. The tube wall 102a defines a hollow cylinder. The tube wall 102a is elastic, being preferably stiffly elastic, wherein the shape of the tube, particularly the outer surface region thereof, is resiliently reversible in response to a compressive force, including a radially inwardly directed compressive force, being applied thereto. Each elastic tube 102, particularly the tube wall 102a, includes at least one tube attachment feature 103 (e.g., first attachment feature) that is selectively engageable with a mating aperture attachment feature 115 (best seen with reference to FIGS. 6-8, 9 and 10A-10E) that is included on the second component 114 together with the alignment features to selectively align and attach the first component 106 to the second component 114 and fix these components in a predetermined orientation relative to one another, particularly orientations having predetermined aesthetic appearance characteristics, such as predetermined gaps between adjacent edges of the first component and second component, including a uniform gap spacing. As discussed above, any suitable elastically deformable material may be used for the first component 106, elastic tubes 102 and tube attachment feature 103, particularly those materials that are elastically deformable when formed into the features described herein. The elastic tubes 102 and tube attachment features 103 may be formed in any suitable manner. The elastic tubes 102 and tube attachment features 103 may be integrally formed or manufactured with the first component 106, or they may formed together separately and attached to the first component, or they may both be formed entirely separately and attached to the first component. When formed separately, they may be formed from different materials than those of the first component 106 to provide a predetermined elastic response characteristic, for example. The material, or materials, may be selected to provide a predetermined elastic response characteristic of any or all of the first component 106, elastic tubes 102 or tube attachment features 103. The predetermined elastic response characteristic may include, for example, a predetermined elastic modulus.

A plurality of mutually separated aperture alignment features (serving as female alignment features) 110 (hereinafter referred to simply as “apertures”) are disposed in a second surface 112 of a second component 114, being located in one-to-one correspondence with the plurality of elastic tubes 102; that is, for each elastic tube is a respective aperture into which it is receivable. Thus, the plurality of apertures is geometrically distributed in coordinated relationship to a geometrical distribution of the plurality of elastic tubes such that each elastic tube is receivable into its respect aperture. While the apertures 110 are shown as elongated slots, it is clear the aperture shape could be otherwise, such as for example an elongated hole, a generally round hole, etc. In an embodiment, an aperture wall 116 which defines the entrance opening demarcation of the aperture alignment features 102 is beveled 116a, which may include all manner of flat or curved bevels, or a combination thereof. The aperture wall 116 is also elastic, being preferably stiffly elastic, wherein the shape of the aperture 110, particularly the aperture wall 116 and the deformable region proximate the wall, is resiliently reversible in response to a compressive force, including a radially outwardly directed compressive force, being applied thereto by the corresponding elastic tube 102. Each aperture 110, particularly the aperture wall 116, includes at least one aperture attachment feature 115 (e.g., second attachment feature) that is selectively engageable with a mating tube attachment feature 103 that is included on the elastic tubes 102 of the first component 106 to selectively align and attach the first component 106 to the second component 114 and fix these components in a predetermined orientation relative to one another, particularly orientations having predetermined aesthetic appearance characteristics, such as predetermined gaps between adjacent edges of the first component and second component, including a uniform gap spacing. All of the materials and component types described above for the first component 106 may also be employed for the second component 114. The material selected for the second component 114 may be the same material as the first component 106 or a different material. For example, the elastic modulus of the first component 106 and second component 114 may be the same or different. The elastic tubes 102 and tube attachment features 103 may be formed in any suitable manner. The apertures 110 and aperture attachment features 115 may be integrally formed or manufactured with the second component 114, or they may formed together separately in the second component, or they may both be formed separately in the second component. The apertures 110 and aperture attachment feature 115 may be formed to provide a predetermined elastic response characteristic, for example. The material, or materials, may be selected to provide a predetermined elastic response characteristic of any or all of the second component 114, apertures 110 or aperture attachment features 115. The predetermined elastic response characteristic may include, for example, a predetermined elastic modulus.

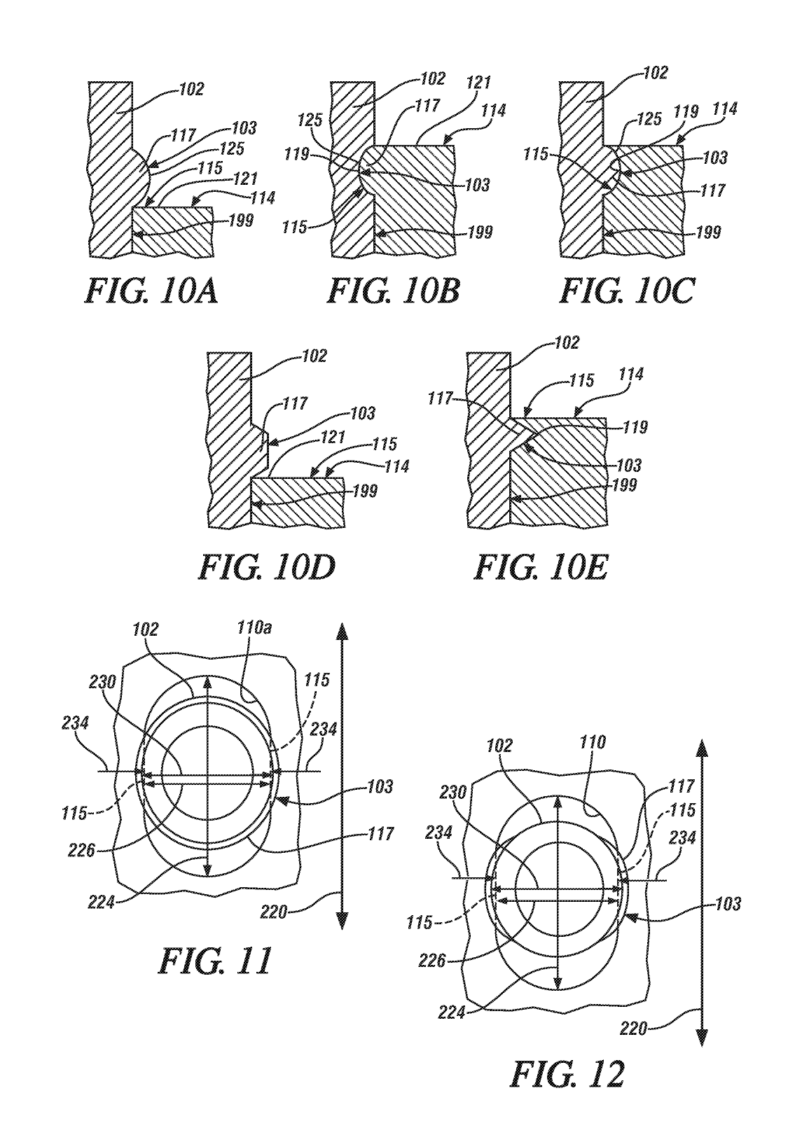

As shown in FIGS. 10A-10E, in the attachment system described herein one of the tube attachment feature 103 or the aperture attachment feature 115 may include at least one protrusion 117 or recess 119 or shoulder 121 disposed on the respective elastic tube 102 or aperture 110. The other of the tube attachment feature 103 or the aperture attachment feature 115 may include at least one mating feature, including a recess 119 or shoulder 121 or protrusion 117, respectively. For example, in one embodiment, the tube attachment feature 103 is a protrusion 117 and the aperture attachment feature 115 is a mating protrusion 117 or recess 119 or shoulder 121. In another embodiment, the aperture attachment feature 115 is a protrusion 117 and the tube attachment feature 103 is a mating protrusion 117 or recess 119 or shoulder 121. In yet another embodiment, the tube attachment feature 103 disposed on each elastic tube comprises a protrusion 117 or recess 119 and the mating aperture attachment feature 115 includes a respective recess 119 or protrusion 117. In still another embodiment, the tube attachment features 103 comprise protrusions disposed on the elastic tubes 102 and the aperture attachment features 115 comprise shoulders 121 of the apertures 110. The tube attachment features 103, including the protrusions 117 or the recesses 119, are spaced away from the attachment ends 123 (best seen with reference to FIG. 10) of the elastic tubes 102.

As illustrated in each of FIGS. 10A-10E by reference numeral 199, the outer side wall of the elastic tubes 102 are dimensioned to be in hard contact with the edge of the apertures 115, thereby ensuring positive engagement of the tube attachment features 103 with the aperture attachment features 115.

In the case of elastic tubes 102, the elastic deformation of the tubes includes resiliently reversible elastic deformation of each tube wall 102a and the tube attachment feature 103, such as the protrusion 117 or recess 119 or shoulder, disposed thereon. In the case of apertures 110, the elastic deformation of the apertures further includes resiliently reversible elastic deformation of each aperture wall 116 and the aperture attachment feature 103, such as the protrusion 117 or recess 119 or shoulder 121, disposed thereon.

The protrusions 117 may have any suitable shape, including any suitable outwardly protruding profile. In one embodiment, the elastic tubes 102 have tube attachment features 103 comprising protrusions 117 that include axially outwardly curved outer surfaces 125 (see FIG. 10A for example). This may include any suitable axially outwardly curved outer surfaces 125. In one embodiment, the axially outwardly curved outer surfaces 125 include surfaces having a partially circular surface profile, and more particularly surfaces having a semicircular surface profile. In one embodiment, the elastic tubes 102 have tube attachment features 103 comprising protrusions 117 that include outwardly beveled outer surfaces, and more particularly a series of adjoining bevels that define a segmented protruding outer surface of protrusions 117, such as a substantially trapezoidal-shaped protrusion profile or trigonal-shaped protrusion profile (see FIGS. 10D and 10E for example).

Reference is now made to FIGS. 11 and 12, where each depict an elastic tube 102 engaged with a slotted aperture 110 having a major axis oriented depicted at 220, a major slot opening depicted at 224, and a minor slot opening depicted at 226. As depicted, the outer diameter 230 of the elastic tube 102 is slightly greater than the minor slot opening 226 of the slotted aperture 110, which produces a purposeful interference fit between the elastic tube 102 and the aperture 110, as seen at 234. This interference fit 234 is overcome during assembly of the first and second components by the elastically deformable characteristic of the elastic tube 102. As also depicted, the protrusion 117 on the elastic tube 102 forms an even greater interference fit with the minor slot opening 226, which is also overcome during assembly by the elastically deformable characteristics of the elastic tube, and which serves to provide positive engagement of the tube attachment features 103 with the aperture attachment features 115 when the first and second components are fully assembled with each other.

As illustrated in FIGS. 11 and 12, the protrusions 117, whether used in conjunction with the elastic tubes 102 or apertures 110 may be generally described as peripherally-extending protrusions as they extend around their periphery, and in the case of cylindrical or tubular features having a circular cross-section may include circumferentially-extending protrusions. As illustrated in FIG. 11, in one embodiment, the peripherally-extending protrusions extend around the entire periphery of the elastic tubes 102 or apertures 110, or both, to which they are incorporated. As illustrated in FIG. 12, in other embodiments, the peripherally-extending protrusions extend around a predetermined portion of the elastic tubes 102 or apertures 110, or both, of the component on which they are incorporated. The predetermined portions, particularly their number and locations on the elastic tubes 102 or apertures 110, or both of them, will be selected so as to engage the mating attachment feature on the other of the components. For example, in certain embodiments, the predetermined portions may be located about 180° from one another about a longitudinal axis of the elastic tubes 102 or apertures 110 on which they are located. In one embodiment, the predetermined portions include at least two peripherally-spaced, arcuate protrusions (FIG. 12). In another embodiment, the predetermined portions include two peripherally-spaced, arcuate protrusions that are radially spaced about 180° from one another about a longitudinal axis of the elastic tubes 102 or apertures 110 on which they are located. The peripherally-spaced, arcuate protrusions may have any suitable arcuate length and spacing from the other arcuate protrusions. In one embodiment, the peripherally-spaced, arcuate protrusions have a length that extends beyond a contact portion of the mating attachment feature, such as a mating recess or shoulder.

The recesses 119 may have any suitable shape, including any suitable inwardly protruding profile. In one embodiment, elastic tubes 102 have tube attachment features 103 comprising recesses 119 that include axially inwardly curved outer surfaces 125 (see FIG. 10B for example). This may include any suitable axially inwardly curved outer surfaces 125. In one embodiment, the axially inwardly curved outer surfaces 125 include surfaces having a partially circular surface profile, and more particularly surfaces having a semicircular surface profile. In one embodiment, the elastic tubes 102 have tube attachment features 103 comprising recesses 119 that include inwardly beveled outer surfaces, and more particularly a series of adjoining bevels that define a segmented recessed outer surface 125. In one embodiment, the attachment features comprise tube attachment features 103 that includes recesses 119 disposed on the elastic tubes 102 and the aperture attachment features 115 comprise shoulders 121 of the apertures 110 that are configured to mate with the recesses 119. The shoulders 121 may also incorporate protrusions 117 that are configured to mate with the recesses 119 (see FIG. 10B for example).

As the first component 106 and the second component 114 are mated together, the alignment features, including the elastic tubes 102 and apertures 110, secure their alignment as described herein. Once the alignment has been realized, the tube attachment features 103 and the aperture attachment features 115 are selectively engaged, such as by pressing until the protrusions 117 engage mating recesses 119 or shoulders 121, so that the first component 106 is attached to the second component 114. The attachment features may be located on the components so that the selective engagement of the tube attachment features 103 and the aperture attachment features 115 provides a clamping force between the first component 106 and the second component 114. For example, the tube attachment features 103 may be located at positions along the elastic tubes 102 so that their engagement with the corresponding aperture attachment feature 115 provides a clamping force. When the first component 106 and second component 114 are components of a vehicle, this is very advantageous because the clamping force, together with the elastic deformation of the alignment features that has these parts in pressing contact already, reduces the tendency of the components to vibrate or rattle against one another, and thus improves the noise, vibration and harshness (NVH) characteristics of the components and the vehicle in which they are installed. The selective engagement of the first attachment features 103 and the second attachment features 115 also provides a stiffened assembly of the first component 106 and second component 114 when the first and second components are mutually mated to each other, including a stiffness that is greater than that realized by using the alignment features alone, since the clamping force between the first component and second component increases the stiffness of the assembly, for example.

The first component 106 and second component 114 may be any suitable components, and are not limited to vehicular components. In one embodiment, the first and second components 106, 114 are motor vehicle components, and may include vehicle exterior or interior components, or a combination thereof.

As depicted at FIG. 6, the diameter 130 of the elastic tubes 102 exceeds a cross-section 132 of the apertures 110, whereby elastic deformation proceeds as each elastic tube is received into its respective aperture. As best shown at FIG. 5, the elastic deformation of the tube wall 102a is locally pronounced due to the beveling 116a of the aperture wall 116, wherein there is provided a relatively small contact area as between the aperture wall contact surface 116b and the tube wall 102a (see FIG. 5). Since the compressive force between the aperture wall and the tube wall is limited to the smaller surface area of the aperture wall contact surface, a higher compressive pressure is provided, see for example the elastic deformation 136 shown at FIGS. 5, 7 and 8.

The process of mating the first component 106 to the second component 114 is both smoothly and easily performed, and may be facilitated by a tapering (smaller diameter with increasing height, as shown comparatively at FIG. 6 by distal and proximal diameters 130a and 130b of the distal and proximal ends 102b, 102c of the tube wall 102a. In this regard, the tapering of the elastic tubes presents a largest diameter 130b at the cross-section of the apertures when the first and second components have arrived at final mating; further, the tapering may present a smallest diameter 130a of the tube wall at the distal end 102b so as to ease initial entry of the elastic tubes into the apertures.

During the mating of the first component 106 to the second component 114, each elastic tube 102 respectively engages its corresponding aperture 110, wherein as the elastic tubes pass into the apertures, any manufacturing variance in terms of position and size thereof is accommodated by elastic deformation on average of the plurality of elastic tubes and apertures. This elastic averaging across the plurality of elastic tubes and apertures 102, 110 provides a precise alignment as between the first and second components 106, 114 when they are finally mated relative to each other, the selective engagement of the tube attachment features 103 and aperture attachment features 114 secure the predetermined alignment and retain the components as an assembly.

The elastic averaging provides elastic deformation of the interface between the plurality of geometrically distributed elastic tube alignment features 102 and the aperture alignment features 110, wherein the average deformation provides a precise alignment, the manufacturing variance being minimized to Xₘᵢₙ, as defined above where Xₘᵢₙ/√N, and where X is the manufacturing variance of the elastic tube and aperture alignment features and N is the number thereof.

Referring now to FIGS. 6 through 8, operation of the elastic tube alignment system 100 according to the invention will be detailed.

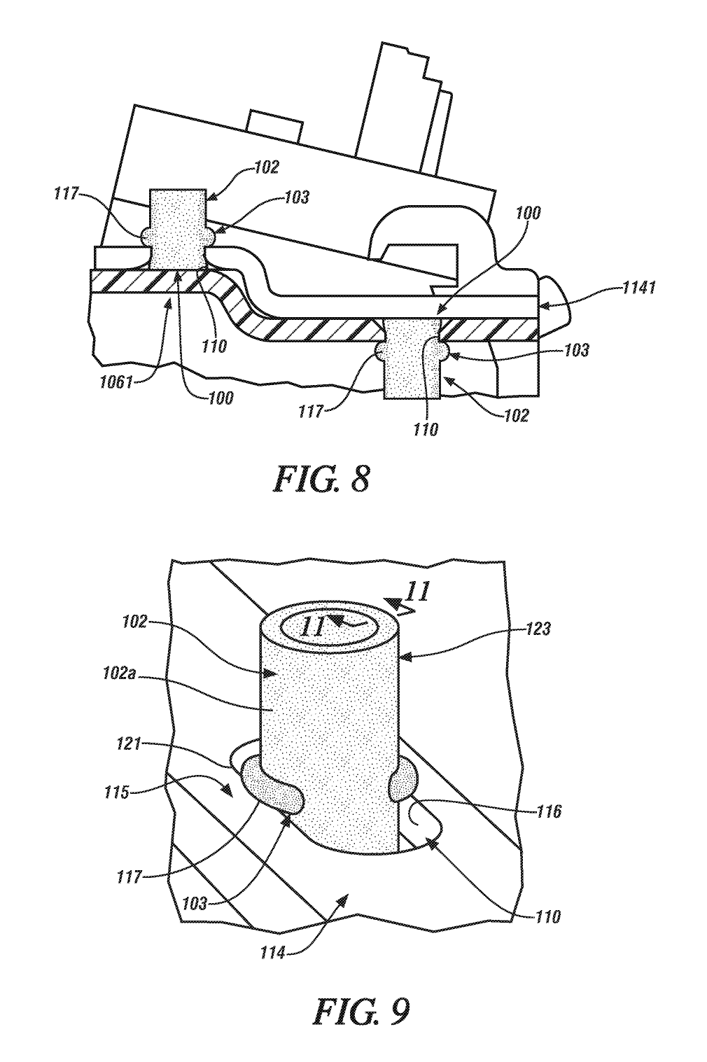

As seen at FIG. 6, the first and second components 106, 114 are brought into close proximity with near alignment. Referring next to FIG. 7, as the first and second components 106, 114 are mated together, the initial contact therebetween is via the plurality of geometrically spaced apart elastic tubes 102 passing into their one-to-one corresponding apertures 110, where the first and second components align to one another. The alignment is precise at FIG. 8, wherein the first and second components 106, 114 have now fully mated. The alignment is precise because of the largest size diameter of elastic tubes relative to the cross-section of the apertures results in elastic deformation, and this elastic deformation is elastic averaged over the plurality of geometrically distributed elastic tubes. When the tube attachment features 103 and aperture attachment features 115 are selectively engaged, the precise alignment becomes manifest, and the visible joint between the two components is a Class A finish. Further affixment modalities may also be implemented to further secure the joint, including to make the joint permanent, such as, for example, the use of heat staking, sonic welding, etc., of the elastic tubes.

The elastic tubes 102 and tube attachment features 103 and the apertures 110 and aperture attachment features 115 may reside on either of the first and second components 106, 114, and indeed, some elastic tubes and some apertures may be present at both the first and second components. By way of example, FIG. 8 is a view as in FIG. 5, wherein now the elastic tube alignment system 100 is characterized by the first component 1061 having both an elastic tube and an aperture, while, likewise, the second component 1141 having also both an elastic tube and an aperture.

Additionally, while cylindrical elastic tubes are preferred, the shape may be non-cylindrical. For example, an elastic tube in accordance with the present invention may have a trilobular shape and may or may not have varying thickness of the tube wall.

It will be understood from the foregoing description, several notable aspects of the invention. The invention: 1) eliminates the manufacturing variation associated with the clearances needed for a 2-way and 4-way locating schemes of the prior art; 2) reduces the prior art manufacturing variation by elastically averaging the positional variation between mating components; 3) eliminates the float of components as is present in the prior art; 4) provides an over constrained condition that reduces the positional variation by averaging out each locating features variation, and additionally stiffens the joint and secures the first component to the second component without the necessity of using additional fasteners; 5) provides more precise location of components; and, 6) provides a stiffened assembly of the mated first and second components with elimination of rattle between the components in elastic deformation with respect to each other.

It will also be understood that while certain exemplary embodiments have been described, other embodiments are also contemplated.

For example, another exemplary embodiment of the invention includes an elastic tube alignment and attachment system for the precise mating and attachment of components, particularly motor vehicle components, wherein when mating and attachment is completed there is a lack of float (or play) as between the male and female alignment features so as to provide a precision alignment and attachment with stiffened positional constraint, yet the aligned mating and attachment proceeds smoothly and effortlessly each time.

The elastic tube alignment and attachment system according to an embodiment of the invention operates on the principle of elastic averaging. A plurality of geometrically separated elastic tube (male) alignment features and first attachment features are disposed on a first component, while a plurality of one-to-one corresponding aperture (female) alignment features and second attachment features are provided on a second component, wherein the elastic tube alignment features have a diameter exceeding a cross-section of the aperture alignment features. However, the first and second components may each have some of the elastic tube alignment features and some of the aperture alignment features so long as they one-to-one correspond so that they are mutually engageable with one another. During the mating of the first component to the second component, each elastic tube alignment feature and first attachment feature respectively engages its corresponding aperture alignment feature and second attachment feature. As the elastic tube alignment features are received into the aperture alignment features, any manufacturing variance in terms of position and size of the elastic tube and aperture alignment features and the first attachment feature and second attachment feature is accommodated by elastic deformation, on average, at the interface between the elastic tube and aperture alignment features, and is also accommodated by the first attachment feature and second attachment feature. This elastic averaging across the plurality of elastic tube and aperture alignment features provides a precise alignment as between the first and second components when they are mated relative to each other, and yet the mating proceeds smoothly and easily.

In another embodiment, the first attachment features are formed on respective ones of the elastic tube alignment features, and are small enough that they can be formed in a die-locked mold configuration. By employing an elastically deformable arrangement where the elastic tube alignment features are capable of undergoing elastically resilient deformation, the first attachment features when engaged with respective ones of the second attachment features will maintain a hard contact between the first attachment features and the second attachment features.

The needed clearance for the male and female alignment features of the prior art is obviated by an embodiment of the invention disclosed herein, as is the reliance on the use of separate fasteners. While separate fasteners may be employed to enhance the attachment of the components, including making the attachment permanent, the plurality of first attachment features and second attachment features provide attachment of the components as the components are mated to one another. In addition, the first attachment features and the second attachment features may be configured to provide selectively releasable attachment or detachment of the components. Since both the alignment features and attachment features utilize elastic deformation of their members, the first attachment features and the second attachment features may be configured to reverse the attachment and allow the components to be detached from one another.

According to another embodiment of the invention, the elastic tube alignment features are elastically deformable by elastic compression of the tube wall of the elastic tube, and at least one of the first attachment feature or the second attachment feature is also elastically deformable by elastic deformation of one of the tube wall or the aperture, which deformation is preferably resiliently reversible. In an exemplary embodiment, the elastic tube alignment features are connected (typically integrally) with a first component in upstanding, perpendicular relation to a predetermined surface of the first component and include first attachment features, which may be protrusions or recesses. Further according to an embodiment of the invention, it is possible, but not required, for the aperture alignment features and second attachment features, which may be recesses or protrusions configured for mating engagement with the first attachment features, to be elastically deformable by elastic expansion of the aperture wall of the aperture alignment feature, which deformation is preferably resiliently reversible. In another exemplary embodiment, the aperture alignment features are disposed at a second component, typically as a slot or a hole in a predetermined surface of the second component, wherein the diameter of the elastic tube alignment features exceeds the cross-section of the aperture alignment features, whereby elastic deformation occurs as each elastic tube alignment feature is received into its respective aperture alignment feature. The process of mating and attachment with precise alignment is both smoothly and easily performed. This may be enhanced by a tapering (smaller diameter with increasing height) of the elastic tube alignment features so as to facilitate their initial entry into the aperture alignment features, and by beveling of the aperture wall of the aperture alignment features so as to locally pronounce the elastic deformation at the interface of the aperture wall with the tube wall, as well as the respective first and second attachment features. However, as will be discussed further below, a beveled aperture wall of the aperture alignment feature is preferred over a tapered elastic tube alignment feature.

In operation, as the first and second components are mated together, the initial contact therebetween is at the plurality of geometrically spaced apart elastic tube alignment features passing into their one-to-one corresponding aperture alignment features. Because of the larger size of the diameter of elastic tube alignment features relative to the cross-section of the aperture alignment features, an elastic deformation occurs at the interface therebetween, and this deformation is averaged over the geometrical distribution of the plurality of elastic tube alignment features. The alignment becomes precise when the first and second components have fully mated because the tapering of the elastic tube alignment features provides a largest diameter to the cross-section of the aperture alignment features when the first and second components have arrived at final mating.

Accordingly, an embodiment of the invention provides an elastic tube alignment and attachment modality for the mating of components, wherein when mating is completed there is a lack of play as between the elastic tube alignment features and the aperture alignment features so as to thereby provide a precision alignment and attachment, yet the mating proceeds smoothly and effortlessly.

As previously discussed, the first attachment features are formed on respective ones of the elastic tube alignment features, and are small enough that they can be formed in a die-locked mold configuration. An example manufacturing process suitable to form the elastic tubes with small first attachment features is a single-axis injection molding machine having a core pin that forms the hollow interior of the elastic tubes, and which is retracted after the elastic tubes are at least partially cured, thereby allowing the elastic tubes to be subsequently ejected from the mold by way of the tube walls elastically and reversibly deforming inward as the first attachment features clear the mold detail that forms the first attachment features. Such an injection molding machine, absent secondary off-axis slide action, is an economical manufacturing process for achieving the benefits disclosed herein.

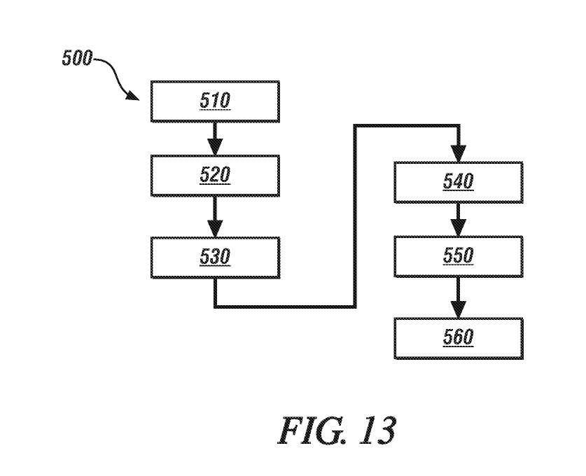

Referring to FIG. 13, the invention also includes a method 500 for precisely aligning and attaching components of a motor vehicle, or other structure, during a mating operation. The method 500 includes providing 510 a first component 106 and providing 520 a second component 114, wherein either of the first and second components are provided with a plurality of upstanding elastic tubes 102 and a plurality of apertures 110 formed therein, as disclosed herein, wherein the plurality of apertures are geometrically distributed in coordinated relationship to a geometrical distribution of the plurality of elastic tubes such that each elastic tube is deformably, interferingly and matingly engageable into a respective aperture, the plurality of upstanding elastic tubes having one of a first attachment feature or a second attachment feature disposed thereon and the corresponding plurality of apertures having the other of the first attachment feature or the second attachment feature disposed thereon, the first attachment features being selectively engageable with the second attachment features. The method also includes mating 530 the first component to the second component by pressing the components together, wherein during pressing the first component is aligned to the second component by each elastic tube being received into its respective aperture. The method further includes elastically deforming 540 an interface between each elastic tube 102 and its respective aperture 110. Still further, the method includes elastically averaging 550 the elastic deformation over the plurality of elastic tubes 102 such that upon mating, a precise location of the first component 106 to the second component 114 transpires. Yet further, the method includes attaching 560 the first component 106 to the second component 114 during pressing by selectively engaging the first attachment features and their respective second attachment features. According to the method 500, providing 510 the first component 106 and 520 the second component 114, a manufacturing variance of size and position of the elastic tubes and the apertures occurs, wherein the manufacturing variance has an average length of X, and wherein said step of elastic averaging provides a reduced manufacturing variance of length Xₘᵢₙ, where Xₘᵢₙ=X/√N, wherein N is the number of the elastic tubes 102, and wherein mating 530 and attaching 560 provides a predetermined orientation of the first component 106 relative to the second component 114.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. An elastic tube alignment and attachment system for aligning components to each other, comprising:
a first component;
a second component;
a plurality of upstanding, axially-extending elastic tubes connected to at least one of the first and second components, each elastic tube having a tube wall;
a plurality of apertures formed in at least one of the first and second components, each aperture having an aperture wall;
a plurality of first attachment features disposed on the plurality of upstanding elastic tubes or the plurality of apertures;
a plurality of corresponding second attachment features disposed on the other of plurality of upstanding elastic tubes or the plurality of apertures;
wherein the plurality of apertures are geometrically distributed in coordinated relationship to a geometrical distribution of the plurality of elastic tubes such that each elastic tube is receivable into a respective aperture;
wherein when each elastic tube is received into its respective aperture an elastic deformation occurs at an interface between the tube wall and the aperture wall, wherein the elastic deformation is responsive to each tube wall having a diameter larger than a cross-section of its respective aperture;
wherein the elastic deformation is elastic averaged over the plurality of elastic tubes such that the first component is precisely located relative to the second component; and
wherein the first attachment features and corresponding second attachment features are selectively engageable to attach the first component to the second component.

2. The elastic tube alignment and attachment system of claim 1, wherein the first attachment feature or the second attachment feature disposed on each elastic tube comprises a protrusion or a recess.

3. The elastic tube alignment and attachment system of claim 2, wherein the protrusion or the recess is spaced away from an attachment end of the elastic tube.

4. The elastic tube alignment and attachment system of claim 1, wherein the elastic deformation comprises resiliently reversible elastic deformation of each tube wall and the first attachment feature or the second attachment feature disposed thereon.

5. The elastic tube alignment and attachment system of claim 1, wherein the elastic deformation further comprises resiliently elastic deformation of each aperture wall and the first attachment feature or the second attachment feature disposed thereon.

6. The elastic tube alignment and attachment system of claim 2, wherein the first attachment features comprise protrusions disposed on the elastic tubes and the second attachment features comprise shoulders of the apertures.

7. The elastic tube alignment and attachment system of claim 6, wherein the protrusions comprise an axially curved outer surface.

8. The elastic tube alignment and attachment system of claim 7, wherein the axially curved outer surface comprises a semicircular surface profile.

9. The elastic tube alignment and attachment system of claim 6, wherein the protrusions comprise a beveled outer surface.

10. The elastic tube alignment and attachment system of claim 2, wherein the first attachment features comprise recesses disposed on the elastic tubes and the second attachment features comprise shoulders of the apertures.

11. The elastic tube alignment and attachment system of claim 1, wherein the selective engagement of the first attachment features and the second attachment features provides a clamping force between the first component and the second component.

12. The elastic tube alignment and attachment system of claim 1, wherein the selective engagement of the first attachment features and the second attachment features provides a stiffened assembly of the first and second components when the first and second components are mutually mated to each other.

13. The elastic tube alignment and attachment system of claim 2, wherein the first attachment feature or the second attachment feature disposed on each elastic tube comprises a protrusion, the protrusion comprising a peripherally-extending protrusion.

14. The elastic tube alignment and attachment system of claim 13, wherein the peripherally-extending protrusion extends around the entire periphery of the elastic tube.

15. The elastic tube alignment and attachment system of claim 13, wherein the peripherally-extending protrusion extends around a predetermined portion of the elastic tube.

16. The elastic tube alignment and attachment system of claim 15, wherein the predetermined portion comprises at least two peripherally-spaced, arcuate protrusions.

17. The elastic tube alignment and attachment system of claim 16, wherein the peripherally-spaced, arcuate protrusions have a length that extends beyond a contact portion of the respective apertures.

18. The elastic tube alignment and attachment system of claim 1, wherein the components are motor vehicle components.

19. A method for precisely aligning and attaching components of a motor vehicle during a mating operation, the method comprising:
providing a first vehicle component;
providing a second vehicle component, wherein either of the first and second vehicle components are provided with a plurality of upstanding elastic tubes and a plurality of apertures formed therein, wherein the plurality of apertures are geometrically distributed in coordinated relationship to a geometrical distribution of the plurality of elastic tubes such that each elastic tube is matingly engageable into a respective aperture, the plurality of upstanding elastic tubes having one of a first attachment feature or a second attachment feature disposed thereon and the corresponding plurality of apertures having the other of the first attachment feature or the second attachment feature disposed thereon, the first attachment features being selectively engageable with the second attachment features;
mating the first vehicle component to the second vehicle component by pressing the components together, wherein during pressing the first vehicle component is aligned to the second vehicle component by each elastic tube being received into its respective aperture;
elastically deforming an interface between each elastic tube and its respective aperture;
elastically averaging the elastic deformation over the plurality of elastic tubes such that upon mating, a precise location of the first vehicle component to the second vehicle component transpires; and
attaching the first component to the second component during pressing by selectively engaging the first attachment features and their respective second attachment features.

20. The method of claim 19, wherein in providing the first vehicle component and the second vehicle component, a manufacturing variance of size and position of the elastic tubes and the apertures occurs, wherein the manufacturing variance has an average length of X, and wherein said step of elastic averaging provides a reduced manufacturing variance of length Xₘᵢₙ, where Xₘᵢₙ=X/√N, wherein N is the number of the elastic tubes, and wherein mating and attaching provides a predetermined orientation of the first component relative to the second component.
